(19) United States
(12) Patent Application Publication
(10) Pub. No.: US 2015/0074206 A1
(43) Pub. Date: Mar. 12, 2015

(54) METHOD AND APPARATUS FOR PROVIDING PARTICIPANT BASED IMAGE AND VIDEO SHARING

(71) Applicant: AT&T Intellectual Property I, L.P., Atlanta, GA (US)

(72) Inventor: CHRISTOPHER BALDWIN, Algonquin, IL (US)

(73) Assignee: AT&T Intellectual Property I, L.P., Atlanta, GA (US)

(21) Appl. No.: 14/025,605

(22) Filed: Sep. 12, 2013

(51) Int. Cl. H04L 12/58

(52) U.S. Cl. CPC H04L 51/10; H04L 51/32
USPC 709/206

(57) ABSTRACT

Methods for forwarding media content are disclosed. For example, a method identifies a known participant captured in the media content, detects an unknown participant captured in the media content and sends a request to a device of the known participant to identify the unknown participant and to provide contact information for the unknown participant. The method then receives from the device of the known participant, the contact information for the unknown participant and sends the media content to a device of the unknown participant using the contact information.

The present disclosure relates generally to communication networks and, more particularly, to systems and methods for supporting and enabling sharing of media among participants.

### BACKGROUND

Wireless network providers currently enable users to capture media on wireless endpoint devices and to share the media with others. For example, many mobile phones are now equipped with integrated digital cameras for capturing still pictures and short video clips. In addition, many mobile phones are equipped to also store audio recordings. Wireless network providers, e.g., cellular network providers, allow users to send picture, video or audio messages to other users on the same wireless network or even on different networks. In addition, users may share media more directly with one another via peer-to-peer/near-field communication methods. For example, the user may send pictures or video as email attachments, multimedia messages (MMS), or may send a link with a Uniform Resource Locator (URL) for the location of the media via email or instant message to others. However, the user must know beforehand the others with whom the user wishes to share the media and must know how to reach the others, e.g., via an email address, a telephone number, a mobile phone number, etc.

### SUMMARY

In one embodiment, the present disclosure discloses a method for forwarding a media content. For example, the method identifies a known participant captured in the media content, detects an unknown participant captured in the media content and sends a request to a device of the known participant to identify the unknown participant and to provide contact information for the unknown participant. The method then receives from the device of the known participant, the contact information for the unknown participant and sends the media content to a device of the unknown participant using the contact information.

In another embodiment, the present disclosure discloses an additional method for forwarding a media content. For example, the method is executed by a processor that identifies a known participant captured in the media content, detects an unknown participant captured in the media content and obtains biometric data and contact information for a plurality of contacts that include the unknown participant. The biometric data and contact information for the plurality of contacts is obtained wirelessly from a device of the known participant that is proximate to the processor. The processor then identifies the unknown participant in the media content using the biometric data that is obtained wirelessly and sends the media content to a device of the unknown participant that is identified using the contact information.

In still another embodiment, the present disclosure discloses a further method for forwarding a media content. For example, the method identifies a known participant captured in the media content, detects an unknown participant captured in the media content and obtains biometric data and contact information for a plurality of contacts that include the unknown participant. The biometric data and contact information is obtained from a server of a social network that provides biometric data of contacts who are first and second degree contacts of a user of a device that includes the processor. The known participant is a first degree contact of the user, the unknown participant is a first degree contact of the known participant, and the unknown participant is a second degree contact of the user via the known participant. The method then identifies the unknown participant in the media content using the biometric data that is obtained from the server of the social network and sends the media content to a device of the unknown participant that is identified using the contact information.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a flowchart of a method for sharing a media content, in accordance with the present disclosure;

FIG. 3 illustrates a flowchart of another method for sharing a media content, in accordance with the present disclosure;

FIG. 4 illustrates a flowchart of still another method for sharing a media content, in accordance with the present disclosure; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses methods, non-transitory computer-readable media and devices for sharing media. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one embodiment, the present disclosure is an endpoint device or network server-based method for sharing captured media content among participants. For example, a picture, video or audio recording is captured by an endpoint device and may include the images, likenesses or voices of various participants. The participants captured in the media content may be contacts of, or otherwise socially connected to a user of the device on which the media content is captured. Using biometric data of contacts of the user, the participants in the media content are automatically identified. For example, facial recognition techniques or voice matching techniques may be utilized. Thereafter, the media content can be shared with the identified participants captured in the media content. The user of the device on which the media content is captured or recorded may, over time build up biometric profiles of his or her contacts to enable the automatic identification of participants in the captured or recorded media content. Alternatively, or in addition, a network-based server, such as a server of a social network provider or a server of a communication network provider, may build and store biometric profiles of members of the social network or of network subscribers that can be used to identify participants in the media content. Accordingly, the identification of participants in the media content may be performed locally on an endpoint device that records the media content or within a network to which the media content is uploaded by a user. Additional techniques to help identify unknown participants are described in greater detail below in connection with the exemplary embodiments.

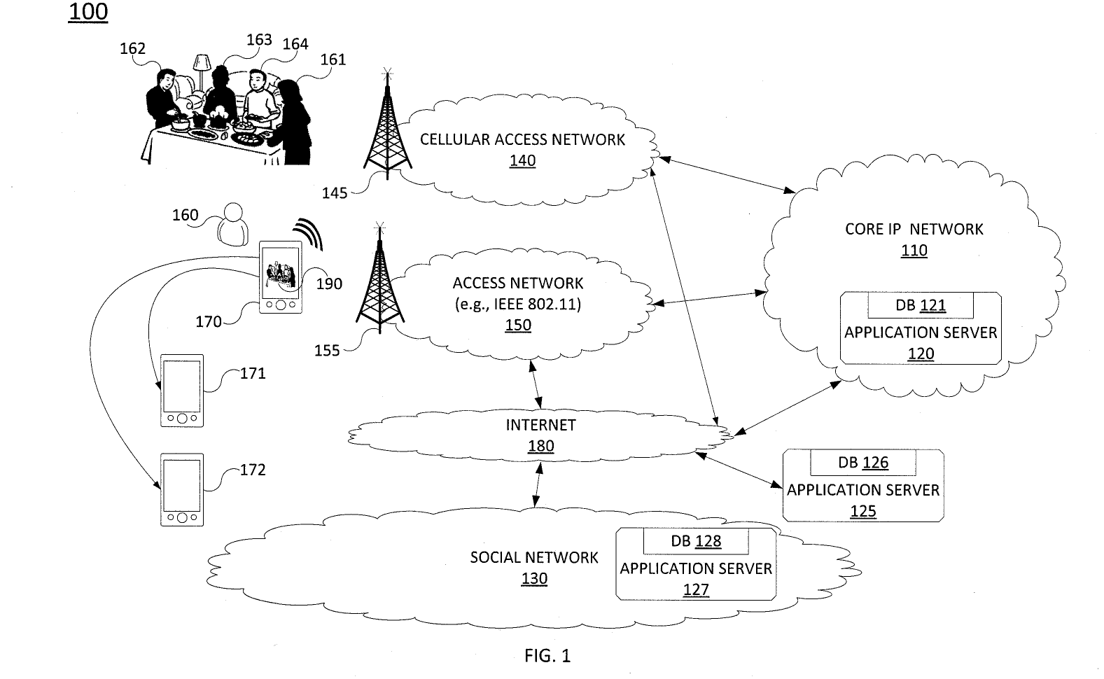

To better understand the present disclosure, FIG. 1 illustrates in greater detail an exemplary system 100 for sharing media content according to the present disclosure. As shown in FIG. 1, the system 100 connects endpoint devices 170, 171 and 172 with one or more application servers via a core internet protocol (IP) network 110, a cellular access network 140, an access network 150 (e.g., Wireless Fidelity (Wi-Fi), IEEE 802.11 and the like) and/or Internet 180. The system 100 also includes a social network 130 for providing social network profile information regarding members of the social network.

In one embodiment, access network 150 may comprise a non-cellular access network such as a wireless local area network (WLAN) and/or an IEEE 802.11 network having a wireless access point 155, a “wired” access network, e.g., a local area network (LAN), an enterprise network, a metropolitan area network (MAN), a digital subscriber line (DSL) network, a cable network, and so forth. As such, endpoint devices 170, 171 and/or 172 may each comprise a mobile phone, smart phone, email device, tablet, messaging device, Personal Digital Assistant (PDA), a personal computer, a laptop computer, a Wi-Fi device, a server (e.g., a web server), and so forth. In one embodiment, one or more of endpoint devices 170, 171 and/or 172 are equipped with digital cameras, video capture devices and/or microphones or other means of audio capture/recording in order to support various functions described herein.

In one embodiment, cellular access network 140 may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, cellular access network 140 may comprise an access network in accordance with any “second generation” (2G), “third generation” (3G), “fourth generation” (4G), Long Term Evolution (LTE) or any other yet to be developed future wireless/cellular network technology. While the present disclosure is not limited to any particular type of wireless access network, in the illustrative embodiment, wireless access network 140 is shown as a UMTS terrestrial radio access network (UTRAN) subsystem. Thus, element 145 may comprise a Node B or evolved Node B (eNodeB).

In one embodiment, core IP network 110 comprises, at a minimum, devices which are capable of routing and forwarding IP packets between different hosts over the network. However, in one embodiment, the components of core IP network 110 may have additional functions, e.g., for functioning as a public land mobile network (PLMN)-General Packet Radio Service (GPRS) core network, for providing Voice over Internet Protocol (VoIP), Service over Internet Protocol (SoIP), and so forth, and/or may utilize various different technologies, e.g., Asynchronous Transfer Mode (ATM), Frame Relay, multi-protocol label switching (MPLS), and so forth. Thus, it should be noted that although core IP network 110 is described as an internet protocol network, this does not imply that the functions are limited to IP functions, or that the functions are limited to any particular network layer (e.g., the Internet layer).

FIG. 1 also illustrates a number of people at an event or gathering. For example, users 160-164 may be attendees at the event. As also illustrated in FIG. 1, a user 160 may take a photograph 190 of other attendees at the event using his/her endpoint device 170. As shown, the photograph 190 may capture images of users 161-164 as participants. Notably, user 160 may then desire to share the photograph 190 with one or more of the participants in the photograph. If the user 160 is close friends with the participants to whom he or she desires to send the photograph, the user 160 may have no difficulty in sending the photograph as an MMS message or as an attachment to an email, since user 160 likely has contact information to send the photograph to these participants. However, if the gathering is very large, or if one or more of the participants are friends of friends that the user 160 may have only recently met, it is more difficult for user 160 to share the photograph with the other participants in the photograph. For example, user 160 may be close friends with and/or already have contact information for user 161. On the other hand, user 160 may have met user 162 for only the first time at this event. Of course user 161 could simply ask user 162 for his or her phone number or email address and send the photograph to user 162 in the same manner as the photograph is sent to user 161, e.g., in a conventional way. However, even where user 160 has previously obtained contact information of a participant, e.g., where the participant is a close friend, it is often time consuming to create a message for sending a photograph or other media content. It is even more time consuming when there are large numbers of participants with whom a user may desire to share a piece of captured media content. Although it is well known to send a single email to a large number of recipients and to send MMS messages to multiple destination telephone numbers, it still requires considerable effort to populate an addressee/recipient list and attach the media content.

In contrast, the present disclosure provides a novel way for users to automatically discover or identify participants in a media content and the share the media content with such identified participants. For example, one embodiment the present disclosure comprises identifying faces of one or more participants in a photograph using facial recognition techniques based upon stored biometric data of the one or more participants, and sending the photograph to one or more of the identified participants based upon contact information associated with the one or more identified participants. For example, in one embodiment, device 170 may have a contact list of various contacts of the user 160. Each contact may have a profile that includes a name, phone number, email address, home and/or business address, birthday, a profile picture, and so forth. In addition, in one embodiment the profile for each contact in the contact list may also include biometric data regarding the contact. For example, in addition to a profile picture, the profile may include one or more photographs of the contact, videos of the contact, voice recordings of the contact and/or metadata regarding the image, voice, dress, gait and/or mannerisms of the contact that are derived from similar sources. In one embodiment, the contact list with biometric data is initially populated from previous photographs, audio recordings, video recordings, and so forth, which capture or depict contacts/friends of the user. Alternatively, or in addition, the contact list may be created from biometric data and contact information of users who are direct/first degree friends/contacts with the user on a social network. For example, the user and a contact may be first degree contacts where one of the user and the contact has indicated to the social network that he or she should be associated with the other. In one embodiment, the user and a contact are first degree contacts where each, i.e., both the user and the contact, have indicated to the social network a desire to be associated with the other.

In one embodiment, with the benefit of biometric data regarding the contacts of the user 160 stored on endpoint device 170, the endpoint device 170 can match participants in the photograph 190 with contacts in the contact list on endpoint device 170. For example, if users 163 and 164 are in the contact list on endpoint device 170, the endpoint device 170 may automatically identify the faces of users 163 and 164 in photograph 190 based upon a facial recognition matching algorithm that matches a set of one or more known images of the faces of users 163 and 164, e.g., from biometric data stored in profiles in the contact list, with faces detected in the photograph 190. Once users 163 and 164 are identified as participants in the photograph 190, endpoint device 170 may automatically send the photograph 190 to the identified users. For example, endpoint device 170 may utilize one or more contact methods to send the photograph 190 to the identified participants depending upon the preferences of the identified participants and the availability of one or more contact methods. For example, endpoint device 170 may have only an email address for user 163, but may have both a phone number and an email address for user 164. Thus, in one embodiment endpoint device 170 may send the photograph 190 to user 164 using both email and a MMS message if the phone number is for a cellular phone.

Returning to the present example, the endpoint device 170 may be capable or recognizing users 163 and 164 in photograph 190 based upon biometric data stored on the device, since users 163 and 164 are already in the contact list of user 160. However, user 162 also appears in the photograph 190, but may not be a previous contact of user 160. Thus, endpoint device 170 may detect a face of user 162 in the photograph 190, but is not able to recognize or match the face to any known person.

To address this issue, the present disclosure provides several solutions. In one example, endpoint device 170 may poll other nearby/proximate devices to solicit biometric data regarding owners of the devices. For example, if two endpoint devices are within range to communicate using near-field communication techniques such as Bluetooth, ZigBee, Wi-Fi, and so forth, or are in communication with a same cellular base station the endpoint devices may be deemed proximate to one another. In one example, endpoint device 170 may solicit from endpoint device 172 biometric data regarding the device owner (i.e., user 162), that can then be used by device 170 to match the unknown face to user 162. Thereafter, having matched the unknown face in photograph 190 to user 162, endpoint device 170 can send photograph 190 to endpoint device 172 in order that user 162 can have a copy. In addition, endpoint device 170 may store for future use an image of user 162 from the photograph 190 along with the contact information and/or further biometric data for user 162 which it receives from device 172.

In another example, endpoint device 170 can poll the devices of other participants who have already been identified in the photograph 190 to provide biometric data on the contacts in the respective contact lists of such other participants. Thus, if user 162 is a second degree contact (e.g., a friend of a friend of user 160) endpoint device 170 may obtain biometric data on user 162 in order to identify user 162 in the photograph 190. In another example, endpoint device 170 may first send the photograph 190 to a device of an identified participant and request that the other device attempt to identify any still unknown participants. This may avoid the unnecessary transfer of biometric data between users or participants who are merely acquaintances and not close friends or direct contacts with one another, thus maintaining a greater degree of privacy for individuals who may implement the present disclosure.

As an example, endpoint device 170 may identify user 161 as a participant in the photograph 190 and may thereafter send the photograph 190 to endpoint device 171 of user 161, requesting that endpoint device 171 attempt to identify any still unknown participants in the photograph 190. Endpoint device 171 may have a contact list of user 161 stored thereon. In addition, user 161's contact list may include an entry for user 162, who is a friend/contact of user 161. More specifically, the entry for user 161 may include contact information for user 162, along with biometric data for user 162. Accordingly, endpoint device 171 may use similar techniques to endpoint device 170 (e.g., facial recognition techniques) in an attempt to identify any still unknown participants in the photograph. In this example, endpoint device 171 may match an unknown face in photograph 190 to user 162. In addition, having made the match, endpoint device 171 may return the contact information for user 161 to endpoint device 170.

In one embodiment, endpoint device 171 may also send biometric data, or a contact profile that include the biometric data for user 161 along with the contact information (e.g., a profile photograph). In addition, in one embodiment the endpoint device 170 may create a new profile or store a received contact profile for user 161. For instance, the endpoint device 170 may store an image of user 162 from the photograph 190 along with the contact information and/or further biometric data for user 162 which it receives from endpoint device 171. Thereafter, endpoint device 170 may forward the photograph 190 to a device of user 162 using the contact information that it obtains from endpoint device 171. For example, endpoint device 170 may send the photograph 190 to endpoint device 172, or another device associated with user 162 (e.g., an email server) using a cellular telephone number, Bluetooth device name, email address, social networking username, and so forth.

In another example, the user 160 may desire to share the photograph 190 with the other participants captured in photograph 190, but may not wish to divulge his/her personal contact information. Similarly, the unknown participants in the photograph 190 may wish to receive an electronic copy of the photograph, but are wary to share their phone numbers or other contact information. Thus, in one embodiment, endpoint device 170 may also request or instruct a device of a known participant (e.g., endpoint device 171) to forward the photograph 190 to any of the unknown participants that it can identify. Thus, in this example, there is no direct communication from the endpoint device 170 of user 160 to the device 172 of the unknown participant (user 162).

In still another example, endpoint device 170 may solicit biometric data from a social network in an effort to identify an unknown participant. For example, social network 130 may store biometric data regarding members of the social network in its member profiles. In this example, users 160-164 may all be members of a social network. Users 161, 163 and 164 may be contacts or friends of user 160 within the social network 130. However, user 162 may only be a contact/friend with user 161. Device 170 may thus query the social network 130 for biometric data/profile information regarding members of the social network. For example, social network 130 may store, e.g., in database (DB) 128 of application server 127 member profiles that include biometric data, such as profile photographs, voice recordings, video recordings, and the like for a number of members of the social network. In one embodiment, social network 130 provides biometric data regarding only first degree and second degree contacts/friends of user 160 in an effort to identify participants in the photograph 190. In one embodiment, the social network 130 only provides biometric data of a second degree contact of the user 160 who also is a first degree contact of a known participant that has already been identified in the photograph 190 (e.g., user 161).

It should be noted that in one example, biometric data from social network 130 is used to pre-populate a contact list on endpoint device 170 with profiles that include contact information and/or biometric data for friends/contacts of user 160, and/or is used to supplement information that is contained in the contact list profiles on device 170. However, in another embodiment, biometric data from social network 130 is the primary or only source of information that is used for identifying participants in photograph 190. For example, device 170 may not have any useful biometric data stored thereon. Rather, it may access the social network 130 to obtain biometric data on friends/contacts of the user 160 at every instance when it needs to identify participants in a photograph or other media content. Thus, in this example endpoint device 170 may identify participants in photograph 190 only to the extent that it is able to obtain from social network 130 biometric data regarding the participants. In any case, endpoint device 170 may be successful in obtaining biometric data and contact information regarding user 162 from social network 130 (e.g., from social network member profiles stored in DB 128 of AS 127) such that device 170 is able to match user 162 to the previously unidentified participant in photograph 190. Accordingly, endpoint device 170 may send the photograph 190 to user 162 using the contact information for user 162, e.g., by sending the photograph as a MMS message to a cellular telephone number for endpoint device 172 (which is the device of user 162).

Similarly, although the foregoing examples describe a process that is performed by or on endpoint device 170, another embodiment the present disclosure is implemented on a network-based application server, e.g., one of application servers 120, 125 or 127. For example, photograph 190 may be captured on endpoint device 170 of user 160 and uploaded to application server (AS) 127 of social network 130. Thereafter, AS 127 may use facial recognition techniques to identify participants in photograph 190 based upon biometric data stored in database (DB) 128 in connection with social network user profiles, e.g., of first and/or second degree contacts/friends of user 160. Once one or more of the participants are thus identified, the AS 127 may then send the photograph 190 to the identified participants. A different embodiment may instead involve AS 125 and DB 126 storing biometric data and/or user contact information, where the AS 125 is operated by a third-party that is different from the operator of core IP network 110 and different from the operator of social network 130. The AS 125 may provide biometric data and contact information in response to a query from an endpoint device, or may itself perform operations to identify known and unknown participants in a photograph or other captured media and to disseminate the captured media to any participants who are ultimately identified.

Similarly, the present disclosure may be implemented by AS 120 and DB 121 storing biometric data and/or user contact information, e.g., operated by a telecommunications network service provider that may own and/or operate core IP network 110 and/or cellular access network 140. For instance, device 170 may upload photograph 190 to AS 120 for identifying participants, determining one or more methods to send the photograph to participants who are identified, and sending the photograph accordingly. In one example, AS 120 may maintain profile information in DB 121, which may include biometric data on network subscribers (where one or more of users 160-164 are network subscribers). In another example, AS 120 may access biometric data from social network profiles of a user's contacts/friends from social network 130. Similarly, in one embodiment one or more subscribers, e.g., user 160, may maintain a network-based contact list, e.g., in DB 121 of AS 120, instead of or in addition to a contact list stored on the user 160's endpoint device 170.

It should be noted that although the above examples describe identifying participants in a photograph using facial recognition techniques, the present disclosure is not so limited. For example, the present disclosure may substitute for or supplement facial recognition techniques by identifying a body shape of a participant and/or by identifying articles of clothing, e.g., where there is access to prior photographs from a same day and where a participant may be wearing the same distinctive outfit. In addition, the above examples are described in connection with sharing of a photograph 190. However, the present disclosure is not limited to any particular media content type, but rather encompasses various forms of media content, e.g., photographs, audio recordings and video recordings (with or without accompanying audio). Thus, in another embodiment the present disclosure is for sharing an audio recording. In such case, the biometric data that is used may comprise a voice recording of a user or participant's voice. Thus, biometric data stored in a contact profile in a contact list on endpoint device 170 or 171, stored in DB 121 of AS 120, stored in DB 126 of AS 126 and/or stored in DB 128 of AS 127 may include one or more of such voice recordings for a user or participant. For example, although a single prior voice recording may be sufficient to match a voice in a captured audio recording, a more accurate or more confident matching may be achievable where there are multiple prior voice recordings or longer prior voice recordings of a particular participant. Similarly, in still another embodiment the present disclosure is for sharing video recordings (which may or may not include an audio component). In such an embodiment, the present disclosure may, for example, identify a participant using a combination of facial recognition techniques and voice matching techniques. In addition, in such a case the useful biometric data may also include gait and/or mannerisms of a participant that are derived from one or more previous video recordings. Thus, the present disclosure may employ any one or a combination of the above types of biometric data in an effort to identify a participant in a captured video.

In one embodiment, the present disclosure may automatically transfer photograph 190 or other captured media content to other participants that are identified. For example, as mentioned above, user 160 may take photograph 190 using endpoint device 170. Endpoint device 170 (or one of the network-based application servers 120, 125 or 127) may then identify users 161-164 using any one or more the techniques described above, e.g., using biometric data from a contact list on endpoint device 170, using biometric data from a contact list on endpoint device 171 of user 161, using biometric data obtained from social network 130, and so forth. Once users 161-164 are identified, endpoint device 170 (or one of the network-based application servers 120, 125 or 127) may then automatically send an email to known email addresses of users 163 and 164.

For example, the email addresses may be stored as part of the contact profile information for the attendees wherever the profile information is stored, e.g., locally on device 170, in DB 121, DB 126, DB 128, in social network 130, etc. Similarly, an MMS message may automatically be sent to cellular telephone numbers associated with devices of users 161 and 162. Thus, different communication channels may be used to send the photograph 190 to different participants that are identified. As still another example, assume that in the first instance only user 161 is identified in photograph 190. Accordingly, endpoint device 170 (or one of the network-based application servers 120, 125 or 127) may request that device 171 of user 161 to automatically send the photograph 190 to devices of any unknown participants that the endpoint device 171 is itself able to identify. It should be noted that the present disclosure is not limited to any particular contact method for sending a photograph or other media content. Thus, the present disclosure may send media content to the identified participants using usernames or other identifiers, e.g., messaging service usernames, social network usernames, IP addresses, Bluetooth device identifiers, and so forth.

In another embodiment, the present disclosure may prompt the user 160 before sending the photograph 190. For instance, endpoint device 170 may present a list or use other means to indicate which participants/users have been identified in the photograph 190, and may include prompts to the user 160 to select the identified participants to which it should send the photograph 190. In addition, the same or similar operations may be followed by a network-based implementation of the present disclosure. For example, endpoint device 170 may maintain a session for user 160 with AS 120. Thus, when AS 120 identifies all participants in the photograph 190 that it is able to identify, AS 120 may prompt the user 160 to select the users/identified participants to which to send the photograph 190.

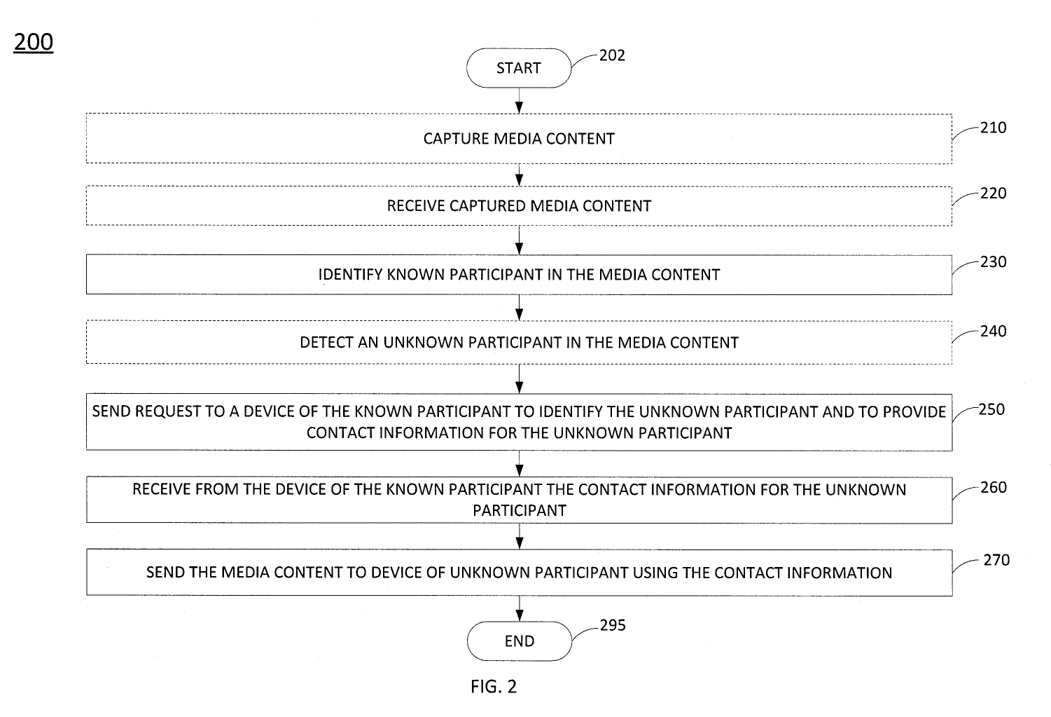

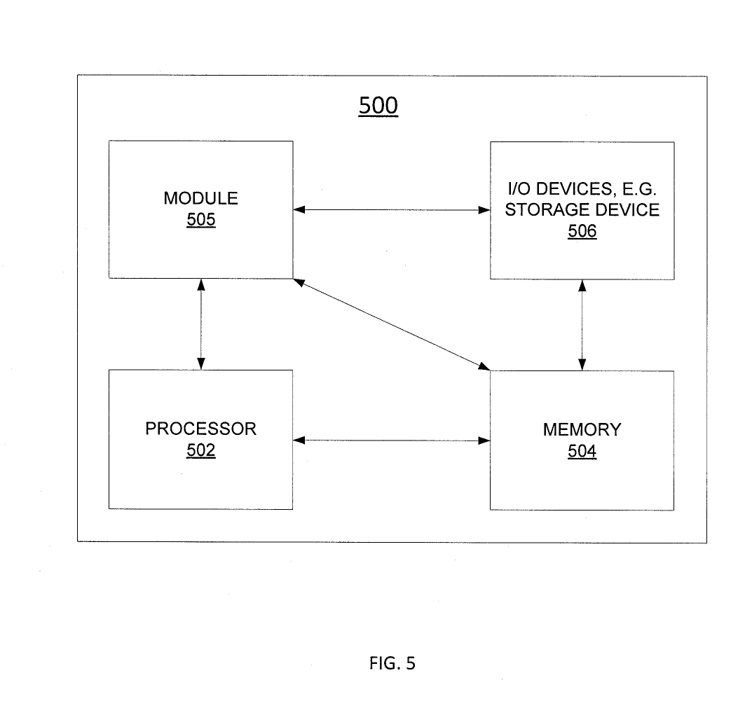

FIG. 2 illustrates a flowchart of a method 200 for forwarding a media content. In one embodiment, steps, functions and/or operations of the method 200 may be performed by an endpoint device, such as endpoint device 170 in FIG. 1, or by a network-based device, e.g., application server 120, 125 or 127 in FIG. 1. In one embodiment, the steps, functions, or operations of method 200 may be performed by a computing device or system 500, and/or processor 502 as described in connection with FIG. 5 below. The method begins in step 205 and proceeds to optional step 210.

At optional step 210, the method 200 captures a media content. For example, the method 200 may capture a photograph, audio recording or video at step 210 using a camera and/or microphone of a smartphone, a digital camera or other multimedia device. In one embodiment, the media content may include a number of participants that are to be identified. In one embodiment, optional step 210 is performed when the method 200 is implemented at an endpoint device, such as endpoint device 170 in FIG. 1.

At optional step 220, the method 200 receives the captured media content. For example, the method 200 may receive from a smartphone, digital camera or other multimedia device the media content that is captured at step 210. For example, a user who has captured the media content using his/her personal endpoint device may upload the media content to a network-based device to perform identification of participants, to contact the participants and to provide the participants with their own electronic copies of the media content. In one embodiment, optional step 220 is performed as part of the method 200 when implemented by a network-based device such as application server 120, 125 or 127 in FIG. 1.

At step 230, the method 200 identifies a known participant in the media content. For example, a photograph that is taken by a user may include the likeness of a friend of the user and who is on a contact list of the user, or who is connected to the user on a social network. Accordingly, at step 230, the method 200 may access biometric data regarding contacts and/or friends of the user who has captured or uploaded the media content. For instance, step 230 may involve accessing a contact list stored on an endpoint device of the user, or stored on a network-based device executing the method 200. The contact list may include a profile having biometric data and contact information for the known participant. In one embodiment, the contact list with biometric data is initially populated from previous photographs, audio recordings, video recordings, and so forth, which capture or depict contacts/friends of the user. Alternatively, or in addition, the contact list may be created from biometric data and contact information of users who are direct/first degree friends/contacts with the user on a social network.

Alternatively, or in addition, step 230 may involve accessing social network profile information from a server of a social network, where the profile information includes biometric data that is useable to identify a participant in the media. In any case, at step 230, the method 200 may compare all or a portion of the media content, e.g., faces, body shapes, clothing, voice identifiers, gaits, mannerisms and so forth from the media content with similar types of biometric data that is obtained for the known contacts/friends of the user. When a match between a contact/friend of the user and a participant in the media content is obtained, the method 200 may note the match. In addition, in one embodiment at step 230, the method 200 may automatically send the media content to the known participant(s) who are identified, or may prompt the user whether he or she would like to send the media content to any identified participant(s). For example, the method 200 may send the media content to the devices of any known and identified participants using contact details such as cellular telephone numbers, email addresses, internet protocol (IP) addresses, social network and/or messaging application usernames, and so forth. In one embodiment, the method 200 may send the media content using near-field communication techniques, e.g., Wi-Fi/peer-to-peer, Bluetooth, and the like, or may send the media content as an attachment to an email, a MMS message, a social networking message, and so forth.

At step 240, the method 200 detects an unknown participant in the media content. For example, the method 200 may identify that there are four participants who appear in the media content, e.g., a photograph or video. In addition, at step 230, the method 200 may previously identify three of the four participants by matching likenesses of the three participants to their biometric data obtained at step 230, e.g., derived from a contact list, database and/or social network profile information. However, while the method 200 may have detected that there are four different participants, it is unable to presently identify one of the participants. For example, the unknown participant may not be a friend/or contact of the user, e.g., the unknown participant is not in a contact list of the user and/or is not a first degree friend/contact of the user in a social network.

In step 250, the method 200 sends a request to a device of one of the known participants requesting the device to identify any unknown participants and to provide contact information for the unknown participants that it is able to identify. For example, the method 200 may have previously sent the media content to the device of the known participant at step 230, or may send the media content at step 250 as part of the request. In one embodiment, the method 200 sends only a portion of the media content in connection with the request. For example, the method 200 may send only a portion, or portions of a picture that include an unidentified face, or may send only an audio clip that includes an unidentifiable voice, for instance. In one embodiment, step 250 comprises sending a request to one, several or all devices of known participants who have previously been identified in the media content.

In one embodiment, the device of a known participant that receives the request may be a portable endpoint device, e.g., a smartphone, a tablet computer or the like. However, in another embodiment the device that receives the request may comprises a home computer, a desktop computer, or even a server of a communications network provider or social network. Thus, a device of a known participant to which the request is sent may broadly comprise any device that is associated with the known participant and which is capable of attempting to identify an unknown participant. In one embodiment, the receiving device to which the request is sent is determined using the same set of contact information from which the method 200 obtains the biometric data used to identify the known participant.

Regardless of the specific device that receives the request or the manner in which the request is sent, the receiving device may then perform similar operations to those performed at step 230. Namely, the receiving device may consult with a contact list stored on the receiving device, or may obtain contact information from a network-based device (e.g., a database of a communication network provider, of a social network provider or of a third-party). More specifically, the receiving device, in one embodiment may have access to biometric data for all contacts/friends of the known participant who is associated with the receiving device. Accordingly, the pool of potential matches for the unknown participant detected at step 240 is significantly increased to include all of the friends/contacts of the known participant that are accessible to the receiving device (the device that receives the request sent at step 250). For instance, the unknown participant may be identified using biometric data of the unknown participant contained on the device of the known participant.

In step 260, the method 200 receives from the device of the known participant contact information for the unknown participant, e.g., when the unknown participant is identified. Thus the receipt of the contact information may also serve as a positive acknowledgement that an unknown participant has been identified. For instance, the device of the known participant that receives the request sent at step 250 may successfully identify one or more unknown participants in a photograph, audio recording or video using accessible biometric data from a contact list stored on the device or accessible to the device from a network-based source (e.g., from a database/application server, a social network, and so forth). In addition, the device may obtain contact information from the same source(s) as the biometric data, e.g., from a profile entry in a contact list, where the profile entry includes biometric data as well as contact information for the unknown participant. The contact information may include one or more ways to communicate with the unknown participant, e.g., a cellular telephone number, an email address, a messaging application username, an IP address, a Bluetooth device name, and the like. As such, when there is a positive match to one of the unknown participants, the device may reply that it has made a positive identification, along with one or more types of contact information for the unknown participant, which is received by the method 200 at step 250.

In one embodiment, step 260 comprises only receiving contact information for the unknown participant. However, in another embodiment the method 200 may additionally receive biometric data for the unknown participant at step 260. For example, the device that identifies the unknown participant and sends the contact information may also include biometric data for the unknown participant in the response. Thus, at step 260 the method 200 may additionally store the contact information along with biometric data for the unknown participant who is identified. Consequently, when encountering an image, likeness or voice of the unknown participant in any subsequent media content, the method 200 may directly identify the unknown participant without having to resort to querying other devices.

At step 270, the method 200 sends the media content to a device of the unknown participant using the contact information received at step 260. For instance, as mentioned above, at step 260 the method 200 may obtain contact information as a positive acknowledgement that an unknown participant has been identified. Accordingly, at step 270 the method 200 may send the media content to the device of the unknown participant based upon the contact information received at step 260. It should be noted that step 270 broadly comprises sending the media content to a device of the unknown participant. However, the method 200 may not necessarily be aware of, or have access to the identity of the specific device of the unknown participant that will ultimately receive the media content. For example, if the media content is sent to an email address, the unknown participant may immediately receive the email at a smartphone while still in the presence of the user who captured the media content. However, it is equally plausible that the unknown participant may access the email at a later time, e.g., via a home computer or a work computer. Thus, the device of the unknown participant to which the media content is sent at step 270 broadly comprises any device that is associated with the unknown participant and that is capable of receiving the media content on behalf of the unknown participant, including a smartphone, personal computer, an email server, a server or other device operated by a social network provider, and so forth.

Following step 270, the method 200 proceeds to step 295 where the method ends.

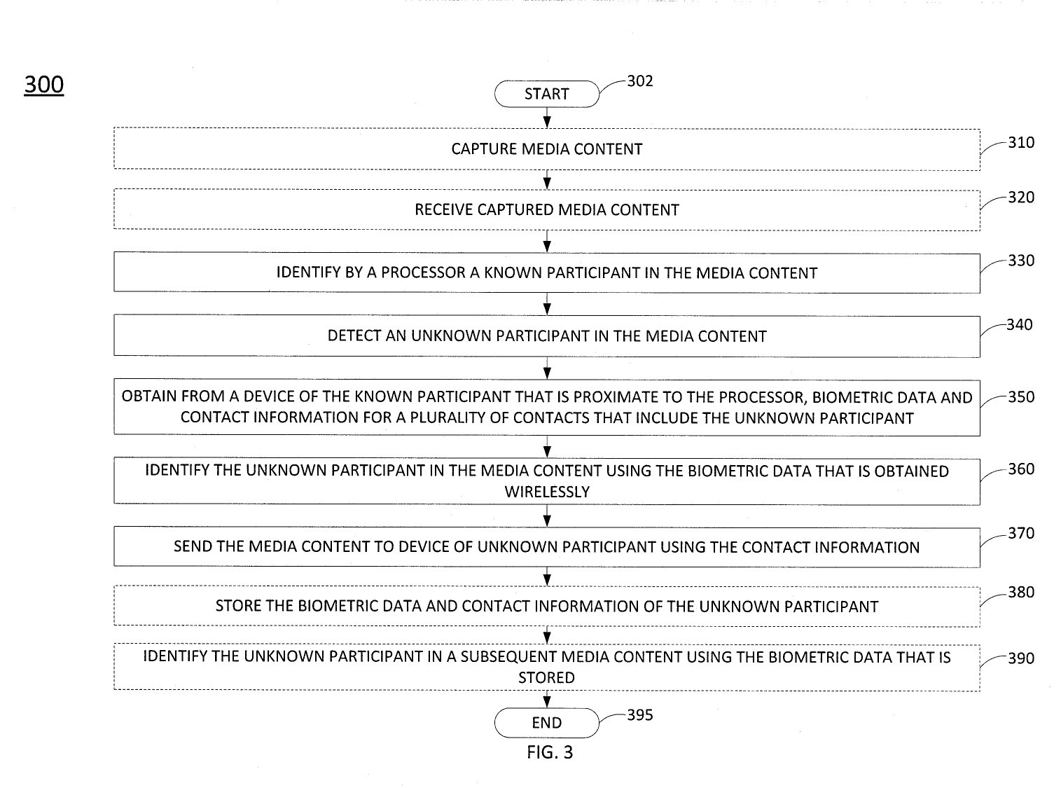

FIG. 3 illustrates a flowchart of method 300 for forwarding a media content. In one embodiment, steps, functions and/or operations of the method 300 may be performed by an endpoint device, such as endpoint device 170 in FIG. 1. In one embodiment, the steps, functions, or operations of method 300 may be performed by a computing device or system 500, and/or processor 502 as described in connection with FIG. 5 below. For illustrative purpose, the method 300 is described in greater detail below in connection with an embodiment performed by a processor, such as processor 502. The method begins in step 305 and proceeds to optional step 310.

At optional step 310, the processor captures a media content. For example, the processor may capture a photograph, audio recording or video at step 310 using a camera and/or microphone of a smartphone, a digital camera or other multimedia device. In one embodiment, the media content may include a number of participants that are to be identified.

At optional step 320, the processor receives the captured media content. For example, the processor may receive the media content from a secure digital (SD) card, from a memory stick or via an email, or may retrieve the captured media content from a local or attached memory, from storage on a server, and so forth.

At step 330, the processor identifies a known participant in the media content. For example, a photograph that is taken by a user may include the likeness of a friend of the user and who is on a contact list of the user, or who is connected to the user on a social network. Accordingly, at step 330, the processor may access biometric data regarding contacts and/or friends of the user who has captured or uploaded the media content. For instance, step 330 may involve accessing a contact list stored on an endpoint device that includes the processor. The contact list may include a profile having biometric data and contact information for the known participant. Notably, step 330 may involve the same or similar functions/operations described in connection with step 230 of the method 200 above.

At step 340, the processor detects an unknown participant in the media content. For example, the processor may identify that there are four participants who appear in the media content, e.g., a photograph or video. In addition, at step 330, the processor may previously identify three of the four participants by matching likenesses of the three participants to their biometric data obtained at step 230, e.g., derived from a contact list, database and/or social network profile information. However, while the processor may have detected that there are four different participants, it is unable to presently identify one of the participants. For example, the unknown participant may not be a friend/or contact of the user, e.g., the unknown participant is not in a contact list of the user and/or is not a first degree friend/contact of the user in a social network. Notably, step 340 may involve the same or similar functions/operations described in connection with step 240 of the method 200 above.

In step 350, the processor obtains wirelessly, from a device of the known participant that is proximate to the processor, biometric data and contact information for a plurality of contacts that include the unknown participant. In one embodiment, step 350 comprises obtaining biometric data and contact information from several or all devices of known participants who have previously been identified in the media content. In one embodiment, the processor sends a request wirelessly to a mobile device of a known participant that is proximate to the processor. In one embodiment, the receiving device to which the request is sent is identified using the same set of contact information from which the method 300 obtains the biometric data used to identify the known participant. In one embodiment, the request is sent using near-field communication techniques such as Bluetooth, ZigBee, Wi-Fi, and so forth. In another embodiment, a request is sent using a MMS message over a cellular network, an email, or other technique. However, in one example, regardless of the manner in which a request is sent, it will only be sent to a device of a known participant or a device of a contact/friend of the user which is proximate to the processor (e.g., proximate to another mobile device that includes the processor). In one embodiment, the processor only contacts devices of known participants that are proximate to the processor. However, in a different embodiment the processor may contact a device of any friend/contact if the friend/contact's device is proximate to the processor. This may be useful where, for example, a friend of a friend appears in a photograph but where the friend-in-common who is present at the event just so happens to not be in that particular photograph.

In one embodiment, two devices are deemed proximate to one another where each device is serviced by a same cellular base station or wireless (e.g., Wi-Fi) access point. In another embodiment, two devices are deemed proximate where the devices are in range to communicate using a near-field communication method. In another embodiment, two devices are deemed proximate when the devices are within a certain distance of one another as determined by cellular triangulation techniques, or as determined using global positioning system (GPS) information obtained from each device.

The receiving device may retrieve biometric data and contact information for all or a portion of the contacts/friends of the known participant who is associated with the receiving device. In addition, the receiving device may then return such information to the processor. Accordingly, at step 350, the processor may receive wirelessly from the device of the known participant a contact list, or a portion of the entries in a contact list which include biometric data and contact information for a plurality of contacts of the known participant. Notably, in one embodiment the biometric data and contact information for the unknown participant is included therewith.

At step 360, the processor identifies the unknown participant in the media content using the biometric data that is obtained wirelessly. For example, the processor may attempt to match biometric data from one or more of the contacts received at step 350 with a portion of the media content that captures the unknown participant. In one embodiment, the processor accesses each entry in a contact list received at step 350, accesses the biometric data, and compares it to a portion of the captured media until a positive match is found. In this way, the pool of potential matches for the unknown participant detected at step 340 is significantly increased to include all of the friends/contacts of the known participant, which are now accessible to the processor.

At step 370, the method 300 sends the media content to a device of the unknown participant using the contact information received at step 350. For example, the contact information received at step 350 may include one or more ways to communicate with the unknown participant, e.g., a cellular telephone number, an email address, a messaging application username, an IP address, a Bluetooth device name, and the like. It should be noted that step 370 broadly comprises sending the media content to a device of the unknown participant.

At optional step 380, the processor stores the biometric data and contact information of the unknown participant, e.g., on a local memory attached to or included in a device that comprises the processor. Consequently, when encountering an image, likeness or voice of the unknown participant in any subsequent media content, the processor may directly identify the unknown participant without having to resort to querying other devices.

At optional step 390, the processor identifies the unknown participant in a subsequent media content using the biometric data that is stored at optional step 380. Advantageously, the processor need not query other devices in order to identify the unknown participant in further media contents that are captured or received. For example, participants at an event may take many photographs which they would like to share. Thus, even if two of the participants are not previously associated with one another, it would be beneficial that the processor need not query external devices for each and every new photograph.

Following step 370, or following optional step 390, the method 300 proceeds to step 395 where the method ends.

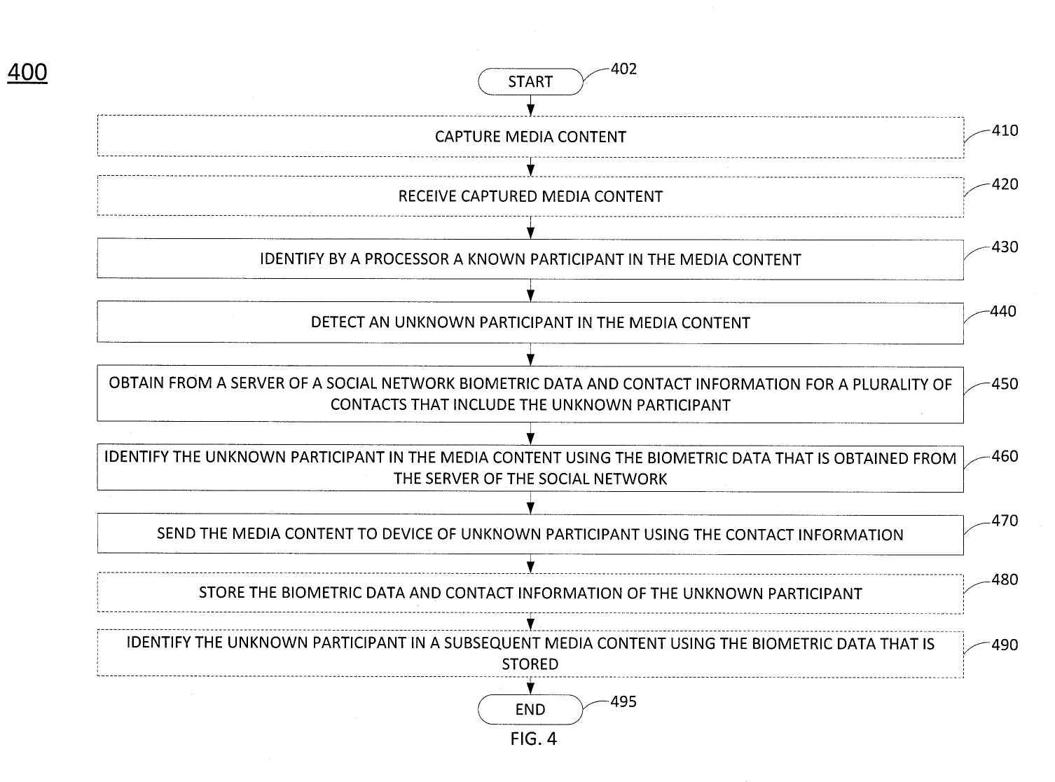

FIG. 4 illustrates a flowchart of still another method 400 for forwarding a media content. In one embodiment, steps, functions and/or operations of the method 400 may be performed by an endpoint device, such as endpoint device 170 in FIG. 1, or by a network-based device, e.g., application server 120, 125 or 127 in FIG. 1. In one embodiment, the steps, functions, or operations of method 400 may be performed by a computing device or system 500, and/or processor 502 as described in connection with FIG. 5 below. The method begins in step 405 and proceeds to optional step 410.

At optional step 410, the method 400 captures a media content. For example, the method 400 may capture a photograph, audio recording or video at step 410 using a camera and/or microphone of a smartphone, a digital camera or other multimedia device. In one embodiment, the media content may include a number of participants that are to be identified. In one embodiment, optional step 410 is performed when the method 400 is implemented at an endpoint device, such as endpoint device 170 in FIG. 1.

At optional step 420, the method 400 receives the captured media content. For example, the method 400 may receive from a smartphone, digital camera or other multimedia device the media content that is captured at step 410. For example, a user who has captured the media content using his/her personal endpoint device may upload the media content to a network-based device to perform identification of participants, to contact the participants and to provide the participants with their own electronic copies of the media content. In one embodiment, optional step 420 is performed as part of the method 400 when implemented by a network-based device such as application server 120, 125 or 127 in FIG. 1.

At step 430, the method 400 identifies a known participant in the media content. For example, a photograph that is taken by a user may include the likeness of a friend of the user and who is on a contact list of the user, or who is connected to the user on a social network. Accordingly, at step 430, the method 400 may access biometric data regarding contacts and/or friends of the user who has captured or uploaded the media content. For instance, step 430 may involve accessing a contact list stored on a device executing the method 400. The contact list may include a profile having biometric data and contact information for the known participant. Notably, step 430 may involve the same or similar functions/operations described in connection with steps 230 or 330 of the respective methods 200 and 300 above.

At step 440, the method 400 detects an unknown participant in the media content. For example, the method 400 may identify that there are four participants who appear in the media content. In addition, at step 430, the method 400 may previously identify three of the four participants by matching likenesses of the three participants to their biometric data obtained at step 430, e.g., derived from a contact list or profile information stored on a device executing the method 400 or obtained from a network-based server and/or database. However, while the method 400 may have detected that there are four different participants, it is unable to presently identify one of the participants. Notably, step 440 may involve the same or similar functions/operations described in connection with steps 240 and 340 of the respective methods 200 and 300 above.

In step 450, the method 400 obtains from a server of a social network, biometric data and contact information for a plurality of contacts that include the unknown participant. Notably, in one embodiment the server of the social network only provides biometric data and contact information of contacts/friends who are first and second degree contacts of the user. In addition, in one embodiment the server only provides biometric data of a second degree contact of the user who also is a first degree contact of a known participant that has already been identified in the media content. In one embodiment, the method 400 sends a request to the server of the social network seeking available biometric data and contact information for a plurality of contacts, where the request includes the identity of the known participant who is identified in the media content at step 430. The server of the social network may reply with a list of friends/contacts of the known participant. In one embodiment, the server may provide one or more profiles/entries for the respective friends/contacts of the known participant, where each profile includes biometric data and contact information for one of the friends/contacts. Notably, in one embodiment the biometric data and contact information for the unknown participant is included therewith.

At step 460, the method 400 identifies the unknown participant in the media content using the biometric data that is obtained from the server of the social network. For example, the method 400 may attempt to match biometric data from one or more of the contacts received at step 450 with a portion of the media content that captures the unknown participant. In one embodiment, the method 400 accesses each entry or profile in a list of contacts/friends received at step 450, accesses the biometric data, and compares it to a portion of the captured media until a positive match is found. In this way, the pool of potential matches for the unknown participant detected at step 440 is significantly increased to include all of the friends/contacts of the known participant from a social network, which are now accessible to the method 400.

At step 470, the method 400 sends the media content to a device of the unknown participant using the contact information received at step 450. For example, the social network profile of the unknown participant that is received at step 450 may include contact information that provides one or more ways to communicate with the unknown participant, e.g., a cellular telephone number, an email address, a messaging application username, an IP address, a Bluetooth device name, and the like.

At optional step 480, the method 400 stores the biometric data and contact information of the unknown participant, e.g., on a local memory attached to or included in a device that comprises the processor. Consequently, when encountering an image, likeness or voice of the unknown participant in any subsequent media content, the method 400 may directly identify the unknown participant without having to resort to querying other devices.

At optional step 490, the method 400 identifies the unknown participant in a subsequent media content using the biometric data that is stored at optional step 480. Advantageously, the method 400 need not query other devices (e.g., a server of a social network) in order to identify the unknown participant in further media contents that are captured or received. For example, participants at an event may take many photographs which they would like to share. Thus, even if two of the participants are not previously associated with one another, it would be beneficial that the method 400 need not query external devices, such as a social network server, for each and every new photograph.

Following step 470, or following optional step 490, the method 400 proceeds to step 495 where the method ends.

It should be noted that although not specifically specified, one or more steps, functions or operations of the respective methods 200, 300 and/or 400 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIGS. 2-4 that recite a determining operation or involve a decision do not necessarily require that both branches of the determining operation be practiced. In other words, one of the branches of the determining operation can be deemed as an optional step.

FIG. 5 depicts a high-level block diagram of a general-purpose computer or system suitable for use in performing the functions described herein. For example, any one or more components or devices illustrated in FIG. 1 or described in connection with the methods 200, 300 or 400 may be implemented as the system 500. As depicted in FIG. 5, the system 500 comprises a hardware processor element 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for forwarding a media content, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps functions and/or operations of the above disclosed methods. In one embodiment, the present module or process 505 for forwarding a media content can be implemented as computer-executable instructions (e.g., a software program comprising computer-executable instructions) and loaded into memory 504 and executed by hardware processor 602 to implement the functions as discussed above. As such, the present module or process 505 for forwarding a media content as discussed above in methods 200, 300 and 400 (including associated data structures) of the present disclosure can be stored on a non-transitory (e.g., tangible or physical) computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for forwarding a media content, comprising:
identifying, by a processor, a known participant captured in the media content;
detecting, by the processor, an unknown participant captured in the media content;
sending, by the processor, a request to a device of the known participant to identify the unknown participant and to provide contact information for the unknown participant;
receiving, by the processor, from the device of the known participant, the contact information for the unknown participant; and
sending, by the processor, the media content to a device of the unknown participant using the contact information.

2. The method of claim 1, wherein the known participant is identified using biometric data of the known participant that is stored on a device that includes the processor.

3. The method of claim 2, wherein the biometric data of the known participant comprises information that was received from a server of a social network, wherein the known participant is identified by comparing the biometric data to a portion of the media content.

4. The method of claim 1, wherein the unknown participant is identified using biometric data of the unknown participant contained on the device of the known participant.

5. The method of claim 4, wherein the media content comprises a photograph and the biometric data of the unknown participant comprises an image of the unknown participant.

6. The method of claim 5, wherein the unknown participant is identified by comparing a face of the unknown participant from the image to a face of the unknown person in the media content using a facial recognition tool.

7. The method of claim 4, wherein the media content comprises an audio recording and wherein the biometric data comprises a voice recording of the unknown participant.

8. The method of claim 4, wherein the media content comprises a video and wherein the biometric data comprises a stored video of the unknown participant.

9. The method of claim 8, wherein the unknown participant is identified by comparing a gait of the unknown participant in the stored video to a gait of the unknown person in the video.

10. The method of claim 1, wherein the processor comprises a processor of an endpoint device.

11. The method of claim 1, further comprising:
capturing the media content.

12. The method of claim 1, wherein the processor comprises a processor of an application server in a communication network, wherein the method further comprises:
receiving the media content from an endpoint device.

13. A method for forwarding a media content, comprising:
identifying, by a processor, a known participant in the media content;
detecting, by a processor, an unknown participant in the media content;
obtaining wirelessly by the processor from a device of the known participant that is proximate to the processor, biometric data and contact information for a plurality of contacts that include the unknown participant;
identifying, by the processor, the unknown participant in the media content using the biometric data that is obtained wirelessly; and
sending, by the processor, the media content to a device of the unknown participant that is identified using the contact information.

14. The method of claim 13, wherein the known participant is identified using biometric data of the known participant that is stored on a device that includes the processor.

15. The method of claim 14, wherein the device of the known participant that is proximate to the processor is deemed proximate to the processor when it is within a range to communicate with the processor using near-field communication techniques.

16. The method of claim 13, wherein the processor is a processor of a mobile device, wherein the device of the known participant that is proximate to the processor is a different mobile device, and wherein the device of the known participant that is proximate to the processor is deemed proximate to the processor when both are in communication with a same base station.

17. The method of claim 13, further comprising:
storing the biometric data and contact information of the unknown participant on a device that includes the processor; and
identifying the unknown participant in a subsequent media content using the biometric data that is stored.

18. A method for forwarding a media content, comprising:
identifying, by a processor, a known participant in the media content;
detecting, by a processor, an unknown participant in the media content;
obtaining, by the processor, from a server of a social network, biometric data and contact information for a plurality of contacts that include the unknown participant, wherein the server of the social network provides biometric data of contacts who are first and second degree contacts of a user of a device that includes the processor, wherein the known participant is a first degree contact of the user, wherein the unknown participant is a first degree contact of the known participant, and wherein the unknown participant is a second degree contact of the user via the known participant;
identifying, by the processor, the unknown participant in the media content using the biometric data that is obtained from the server of the social network; and
sending, by the processor, the media content to a device of the unknown participant that is identified using the contact information.

19. The method of claim 18, wherein the processor comprises a processor of an endpoint device.

20. The method of claim 18, wherein the processor comprises a processor of an application server in a communication network, wherein the method further comprises:
receiving the media content from an endpoint device.
